(19) United States
(12) Patent Application Publication
(10) Pub. No.: US 2010/0101692 A1
(43) Pub. Date: Apr. 29, 2010

(54) COMPOSITION FOR CORRETING FORCE VARIATIONS AND VIBRATIONS OF A TIRE-WHEEL ASSEMBLY

(75) Inventors: Robert D. Fogal, SR., Chambersburg, PA (US); Robert D. Fogal, JR., Newville, PA (US)

Correspondence Address: HAHN LOESER & PARKS, LLP, One GOJO Plaza, Suite 300, AKRON, OH, 44311-1076, US

(73) Assignee: INTERNATIONAL MARKETING, INC., Chambersburg, PA (US)

(21) Appl. No.: 12/608,735

(22) Filed: Oct. 29, 2009

Related U.S. Application Data
(60) Provisional application No. 61/109,342, filed on Oct. 29, 2008.

(51) Int. Cl. F16F 15/32

(52) U.S. Cl. 152/154.1

(57) ABSTRACT

The present invention comprises apparatus and methods for improved correction of force variations and/or frequencies of a tire-wheel assembly. In particular embodiments, the invention comprises a system for improved correction of force variations and/or dampening of vibrations in a pneumatic tire-wheel assembly, which includes: a pneumatic tire-wheel assembly; and a plurality of dampening particles positioned within the tire-wheel assembly, wherein said particles are formed of at least one energy dampening viscoelastic material. In other embodiments, the present invention comprises a method for improved the equalization of force variations and vibrations of a pneumatic tire-wheel assembly comprising the steps of: providing a pneumatic tire-wheel assembly; providing a plurality of impact dampening particles, wherein the particles are formed of at least one energy dampening viscoelastic material; and, placing said plurality of particles in free movable relationship into a pressurization chamber within said tire-wheel assembly.

This application claims priority to, and the benefit of, U.S. Provisional Patent Application No. 61/109,342, filed Oct. 29, 2008, the disclosure of which is herein incorporated by reference in its entirety.

### BACKGROUND OF THE INVENTION

1. Field of the Invention

This invention relates to a composition comprising a plurality of particles for use in reducing force variations and/or vibrations acting on a pneumatic tire and/or wheel during operation of a tire and wheel (“tire-wheel”) assembly. In more specific embodiments, the composition is placed within a pressurized chamber of the tire-wheel assembly for reducing any force variations and/or vibrations acting upon the tire while the tire-wheel assembly is rotating during operation.

2. Description of the Related Art

Tires are utilized by vehicles to improve vehicle handling and ride. Tires, however, are exposed to abnormalities and disturbances, which result in force variations and vibrations acting upon the tire and ultimately the vehicle. Ultimately, force variations and vibrations reduce vehicle handling, stability, and ride, while also causing excessive tire wear. Accordingly, it is generally desirous to reduce, if not eliminate, force variations and vibrations that act upon the tire, the tire-wheel assembly, and ultimately the vehicle.

A vehicle generally comprises an unsprung mass and a sprung mass. The unsprung mass generally includes portions of the vehicle not supported by the vehicle suspension system, such as, for example, the tire-wheel assembly, steering knuckles, brakes and axles. The sprung mass, conversely, generally comprises the remaining portions of the vehicle supported by the vehicle suspension system. The unsprung mass can be susceptible to disturbances and vibration originating from a variety of sources, such as worn joints, wheel misalignment, wheel non-uniformities, and brake drag. Disturbances and vibrations may also originate from a tire, which may be caused by tire imperfections, such as tire imbalance, tire non-uniformities, and irregular tread wear.

A tire imbalance generally results from a non-uniform distribution of weight around the tire relative to the tire's axis of rotation. An imbalance may also arise when the tire weight is not uniform from side-to-side, or laterally, along the tire. Tire imbalances may be cured by placing additional weight at particular locations to provide a balanced distribution of weight about the tire. Balance weights, such as clip-on lead weights or lead tape weights, are often used to correct tire imbalance and balance the tire-wheel assembly. The balance weights are applied to the wheel in a position directed by a balancing machine. Balancing may also be achieved by inserting a plurality of particulates or pulverant material into the tire pressurization chamber, which is forced against the tire inner surface by centrifugal forces to correct any imbalance. However, even perfect balancing of the tire-wheel assembly does not ensure that the tire will not be exposed to other disturbances and vibrations. Even a perfectly balanced tire can have severe vibrations, which may result from non-uniformities in the tire. Accordingly, a balanced tire-wheel assembly may not correct non-uniformities affecting the tire-wheel assembly during vehicle operation.

Tire non-uniformities are imperfections in the shape and construction of a tire. Non-uniformities affect the performance of a tire, and, accordingly, the effects of which can be measured and quantified by determining particular dynamic properties of a loaded tire. Non-uniformities also cause a variation of forces acting on tire 11 through its footprint B. For example, a tire may have a particular conicity, which is the tendency of a tire to roll like a cone, whereby the tire translates laterally as the tire rotates under load. Also, a tire may experience ply steer, which also quantifies a tire's tendency to translate laterally during tire operation; however, this is due to the directional arrangement of tire components within the tire, as opposed to the physical shape of the tire. Accordingly, force variations may be exerted by the tire as it rotates under load, which means that different force levels may be exerted by the tire as portions of the tire having different spring constants enter and exit the tire footprint (the portion of the tire engaging the surface upon which the tire operates). Non-uniformities are measured by a force variation machine.

Force variations may occur in different directions relative to the tire, and, accordingly, may be quantified as radial (vertical), lateral (side-to-side), and tangential (fore-aft) force variations. Radial force variations operate perpendicular to the tire rotational axis along a vertical axis extending upward from the surface upon which the tire operates, and through the center of the tire. Radial forces are strongest in the vertical direction (e.g., wheel “hop”), such as during the first tire harmonic vibration. Radial forces may also have a horizontal (fore-aft, or “surge”) component due to, for example, the radial centrifugal force of a net mass imbalance in the rotating tire. Lateral force variations are directed axially relative to the tire's rotational axis, while tangential force variations are directed perpendicularly to both radial and lateral force variation directions, which is generally in the forward and rearward direction of travel of the tire. Lateral forces cause either tire wobble or a constant steering force. Tangential forces, or fore-aft forces, generally act along the tire footprint in the direction of tire travel, or, in other words, in a direction both tangential to the tire's outer circumference (e.g., tread surface) and perpendicular to the tire's axis of rotation (thus also perpendicular to the radial and lateral forces). Tangential force variations are experienced as a “push-pull” effect on a tire. Force variations may also occur due to the misalignment of the tire-wheel assembly

Because tires support the sprung mass of a vehicle, any dynamic irregularities or disturbances experienced by the tire will cause the transmission of undesirable disturbances and vibrations to the sprung mass of the vehicle, and may result in an undesirable or rough vehicle ride, as well as a reduction in vehicle handling and stability. Severe vibration can result in dangerous conditions, such as wheel tramp or hop and wheel shimmy (shaking side-to-side). Radial force variations are generally not speed dependent, while fore/aft force variations may vary greatly with speed. Tangential force variations are generally insignificant below 40 mph; however, tangential force variations surpass radial force variations as the dominant cause of unacceptable vibration of a balanced tire rotating at over 60 mph and can quickly grow to be a magnitude of twice the radial force variation at speeds approaching 80 mph. Currently, there are no viable methods for reducing tangential force variations.

Methods have been developed to correct for excessive force variations by removing rubber from the shoulders and/or the central region of the tire tread by means such as grinding. These methods are commonly performed with a force variation or uniformity machine which includes an assembly for rotating a test tire against the surface of a freely rotating loading drum. This arrangement results in the loading drum being moved in a manner dependent on the forces exerted by the rotating tire whereby forces may be measured by appropriately placed measuring devices. A computer interprets the force measurements and grinders controlled by the computer remove rubber from the tire tread. However, grinding of the tire has certain disadvantages. For example, grinding can reduce the useful tread life of the tire, it may render the tire visually unappealing or it can lead to the development of irregular wear when the tire is in service on a vehicle. Studies have shown that grinding does not reduce tangential force variation (Dorfi, “Tire Non-Uniformities and Steering Wheel Vibrations,” Tire Science & Technology, TSTCA, Vol. 33, no. 2, April-June 2005 p 90-91). In fact, grinding of the tire can also increase tangential force variations within a tire.

Presently, there is a need to effectively reduce tire force variations, as well as vibrations propagating through a tire. This would allow tires having excessive force variations to be used. For example, new tires having excessive force variations may be used instead of being discarded. Further, there is a need to reduce and/or correct force variations and vibrations that develop during the life of a tire, such as due to tire wear or misalignment of a vehicle component, where such reduction and/or correction may occur concurrently as any such force variation and/or vibration develops (i.e., without dismounting to analyze and/or correct each such tire after a performance issue is identified). There also remains a need to reduce rolling resistance and reduce impact energy loss at the tire footprint.

### SUMMARY OF THE INVENTION

The present invention comprises apparatus and methods for improved correction of force variations and/or frequencies of a tire-wheel assembly. In particular embodiments, the invention comprises a system for improved correction of force variations and/or dampening of vibrations in a pneumatic tire-wheel assembly, which includes: a plurality of dampening particles adapted for placement within the tire-wheel assembly, wherein said particles are formed of at least one energy dampening viscoelastic material. In particular embodiments, the system includes a pneumatic tire-wheel assembly.

In other embodiments, the present invention comprises a method for improved the equalization of force variations and vibrations of a pneumatic tire-wheel assembly comprising the steps of: providing a pneumatic tire-wheel assembly; providing a plurality of impact dampening particles, wherein the particles are formed of at least one energy dampening viscoelastic material; and, placing said plurality of particles in free movable relationship into a pressurization chamber within said tire-wheel assembly for improving equalization of any force variations and/or vibrations of the tire-wheel assembly upon rotation of the tire-wheel assembly. In further embodiments, the method includes the step of determining that the tire-wheel assembly has force variations for correction (i.e., to be corrected). In still further embodiments, the method includes the step of rotating the tire-wheel assembly under load after performing the step of placing, wherein said plurality of dampening particles are positioned to equalize force variations and/or vibrations of said tire-wheel assembly.

The foregoing and other objects, features and advantages of the invention will be apparent from the following more detailed descriptions of particular embodiments of the invention, as illustrated in the accompanying drawings wherein like reference numbers represent like parts of the invention.

### BRIEF DESCRIPTION OF THE DRAWINGS

FIG. 1 shows a single wheel model of a vehicle showing the relationship of the sprung mass and the unsprung mass;

FIG. 2 is a fragmentary side elevational view of a conventional tire-wheel assembly including a tire carried by a rim, and illustrates a lower portion or “footprint” of the tire tread resting upon and bearing against an associated supporting surface, such as a road;

FIG. 3 is an axial vertical cross sectional view of a conventional rear position unsprung mass of vehicle including the tire-wheel assembly of FIG. 2 and additionally illustrates the lateral extent of the footprint when the tire rests under load upon the road surface;

FIG. 4 is a cross sectional view of the tire-wheel assembly of FIG. 3 during rotation, and illustrates a plurality of radial load forces of different variations or magnitudes reacting between the tire and the road surface as the tire rotates, and the manner in which the particle mixture is forced in position in proportion to the variable radial impact forces;

FIG. 5 is a graph, and illustrates the relationship of the impact forces to the location of the particle mixture relative to the tire when under rolling/running conditions during equalizing in accordance with FIG. 4;

FIG. 6 is a graph of the balancing composition and illustrates the concept of multimodality as described in the present invention; and

FIG. 7 is a graph similar to FIG. 6 and further illustrates the concept of multimodality as described in the present invention.

### DETAILED DESCRIPTION OF THE DRAWINGS

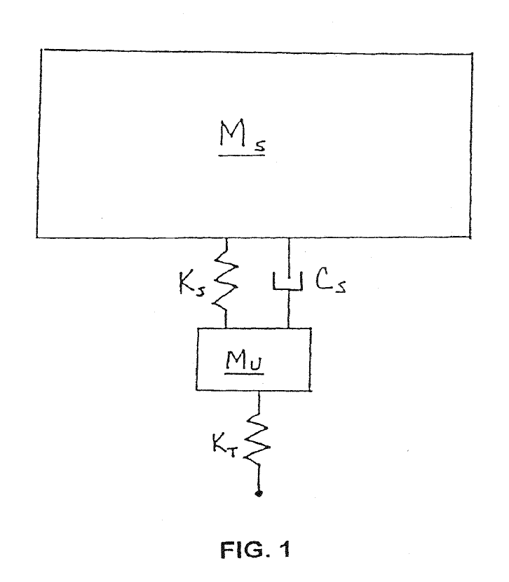

Reference is first made to FIG. 1 of the drawings which shows a single wheel model of a vehicle where symbol Mₛ denotes the mass of a sprung vehicle structure (hereafter referred to as sprung mass) and Mᵤ denotes the mass of an unsprung structure (hereafter referred to as unsprung mass). The unsprung mass Mᵤ generally consists of all of the parts of the vehicle not supported by the vehicle suspension system such as the tire-wheel assembly, steering knuckles, brakes and axles. The sprung mass Mₛ, conversely is all of the parts of the vehicle supported by the vehicle suspension system. Symbol Kₛ denotes the spring constant of a vehicle spring, and Cₛ denotes the damping force of the shock absorber. The unsprung mass Mᵤ can be susceptible to disturbances and vibration from a variety of sources such as worn joints, misalignment of the wheel, brake drag, irregular tire wear, etc. The vehicular tires are resilient and support the sprung mass Mₛ of a vehicle on a road surface as represented by the spring rate of the tires as symbol Kₜ. Any tire or wheel non-uniformities result in a variable spring rate Kₜ which, as the tire rotates, can cause vibration of the unsprung mass Mᵤ. Further, any obstacle encountered by the tire during its operation results in an impact, which causes force variations and vibrations that propagate through the tire and ultimately to the sprung mass Mₛ of the vehicle. In each instance, the vibrations and/or force variations are transmitted to the sprung mass Mₛ, thereby reducing vehicle ride, stability, and/or handling.

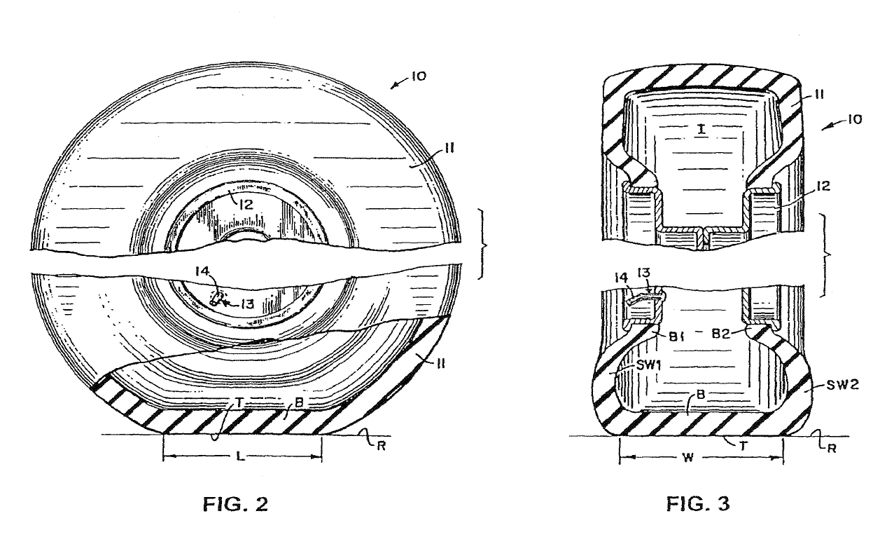

Referring now to FIGS. 2 and 3 of the drawings which illustrate a tire-wheel assembly 10, that is an element of the unsprung mass Mᵤ referred to in FIG. 1. A tire 11 and a wheel (i.e., rim) 12 having a tire inflation valve define the tire-wheel assembly 10. A tire tends to flex radially, and sidewalls SW1, SW2 (FIGS. 2, 3 and 4) which tend to bulge outwardly under load when resting or running upon an operating surface R, which may be, for example, a ground or a road surface. The amount of flex will vary depending upon the tire construction and inflation, as well as the loads acting upon the tire 11.

Tire 11 engages an operating surface R with a tread T, which forms a footprint B as the tread is forced against operating surface R. Footprint B forms a shape having a length L and a lateral width W. Tire 11 also includes beads B1, B2 for securing tire 11 upon wheel 12. Due to tire deflection, tread compression, and/or frictional losses, tire 11 resists rolling under load. Accordingly, each tire 11 has a measurable rolling resistance when operating under load.

Correction of non-uniformities associated with the unsprung mass Mᵤ of a vehicle is beneficial for reducing undesired vibrations that are detrimental to the handling, longevity, and overall performance of the vehicle and its tires. If the non-uniformities are not corrected, excessive force variations may cause excessive vibrations and/or less than optimum vehicle handling, stability, and ride, as well as excessive wear of the tires and other vehicle components. As previously mentioned, non-uniformities and vibrations may exist even if the tire-wheel assembly 10 is balanced (i.e., mass balanced with weights), as non-uniformities may independently exist in the tire, and/or result from brake drag, worn steering or suspension linkages, changing road conditions, tire wear or misalignment, and one or more tires impacting an obstacle (“obstacle impact”), for example. Therefore, there is a present need to reduce, minimize, and/or correct force variations and vibrations arising during operation of tire-wheel assembly 10, and to achieve such in a short period of time (i.e., to minimize the response time for making these force and vibration corrections). This response period is also referred to as the restitution period. It is possible to determine the presence and even amount force variation present in a tire-wheel assembly, or even a tire or wheel separately, by use of any known means in the industry, such by use of a force variation machine, or simply through the use of a vehicle to which the tire-wheel assembly is mounted.

To substantially reduce, minimize, or correct the force variations and vibrations within a tire, a plurality of particulates (or particles) 20 formed of energy-absorbing or dampening viscoelastic material are inserted into a pressurization chamber I within tire-wheel assembly 10. Pressurization chamber I is generally positioned between tire 11 and wheel 12. Dampening particles 20 are able to reduce radial, lateral, and even tangential force variations, and reduce or dampen vibrations operating through tire 11 and the unsprung mass Mᵤ of a vehicle. Dampening particles 20 may also reduce tire rolling resistance. Because particles 20 are free flowing within pressurization chamber I, particles 20 are able to alter their positions within the chamber, as necessary, to adapt to and reduce any force variations and/or vibrations that may arise during tire 11 operation. In addition to reducing force variation, the plurality of particles may also improve and/or correct any weight imbalance of the tire 11 and/or wheel 12, in lieu of using other tire balancing products, such as, for example, lead weights. Tire balancing weights, however, may also be used in conjunction with particles 20.

A plurality of particles 20 may be inserted into pressurization chamber I through the tire pressurization valve; however, in other embodiments, particles 20 may not be supplied through the pressurization valve, as particles 20 are sized larger than the valve opening. Accordingly, the particles 20 are placed into chamber I prior to the tire being fully mounted onto wheel 12. In such embodiments, the particles 20 may be freely placed into the tire 11, or may be placed within the tire 11 in a collective form, such as within a degradable bag or as a briquette of particles 20. The bag or briquette would deteriorate during subsequent tire operation, as the tire warms and/or tumbles during such operation. This process may be repeated with each tire-wheel assembly 10 of a vehicle, and, once completed, each tire-wheel assembly 10 may be rotated with reduced force variations and vibrations, which are dampened and/or absorbed by the particles 20.

Referring now to the composition of particles 20, at least portion of (i.e., a particular quantity of) the particles 20 may be formed from an energy absorbing, or energy dampening, viscoelastic material. Because the viscoelastic material is less reactive (i.e., provides very little reactive bounce), particles 20 may more quickly become positioned along the tire, and may also better maintain any such position, during tire operation to correct tire force variations. Further, the dampening properties may also absorb any vibrations being transmitted through tire 11. A viscoelastic material possesses both elastic and viscous properties. For example, when applying a load to a purely elastic material, all of the energy stored during the corresponding strain of the material is returned after the loading is removed. To the contrary, a purely viscous material does not return any of the strain energy stored after the corresponding loading is removed to provide pure damping. Accordingly, a viscoelastic material combines both elastic and viscous behaviors to provide an energy dampening material that is capable of absorbing energy, so to reduce the impact forces and vibrations acting upon, or being produced by, tire-wheel assembly 10.

The dampening properties of a viscoelastic material can be quantified as having a storage modulus E′ and a loss modulus E″. Storage modulus E′ relates to the elastic behavior (i.e., elastic response) of the viscoelastic material, while loss modulus E″ relates to the viscous behavior (i.e., viscous response) of the viscoelastic material, or, in other words, the material's ability to dissipate energy. Often dampening properties are quantified by tangent delta (tan delta or tan δ), which is the ratio of loss modulus E″ (i.e., viscous response) to the storage modulus E′ (i.e., elastic response), or E″/E′. Tan delta is a measure of hysteresis, which is a measure of the energy dissipated by a viscoelastic elastomer during cyclic deformation (loading and unloading). The use of tangent delta to characterize the viscoelastic properties of materials is well known to one having ordinary skilled in the art. The higher the tan delta, the higher the energy loss. For a perfectly elastic material or polymer, tan delta equals zero. Tan delta is affected by temperature, as well as the structure of the material, such as, for example, the degree of crystallinity, crosslinking, and molecular mass. As the temperature experienced by a pneumatic tire is known to range from the ambient temperature to several hundred degrees during tire operation, the energy dampening material may be selected to have desired tangent delta values for use with an intended tire temperature range.

In particular embodiments, particles 20 are formed of a viscoelastic material having desired hysteresis, or energy absorption or force dampening, properties. In one embodiment, particles 20 are formed of Sorbothane®, a viscoelastic urethane polymer material manufactured by Sorbothane, Inc. of Kent, Ohio. For Sorbothane® material having a durometer of 30 Shore 00, at ambient temperature such material is characterized as having tan delta values of approximately 0.30 at 5 Hertz excitation, 0.38 at 15 Hertz excitation, and 0.45 at 30 Hertz excitation, each taken at 2% strain and 20% compression. For Sorbothane® material having a durometer of 50 Shore 00, at ambient temperature such material is characterized as having tan delta values of approximately 0.56 at 5 Hertz excitation, 0.58 at 15 Hertz excitation, and 0.57 at 30 Hertz excitation, each taken at 2% strain and 20% compression. For Sorbothane® material having a durometer of 70 Shore 00, at ambient temperature such material is characterized as having tan delta values of approximately 0.56 at 5 Hertz excitation, 0.60 at 15 Hertz excitation, and 0.59 at 30 Hertz excitation, each taken at 2% strain and 20% compression. Ambient temperature is room temperature, which is generally between approximately 60-80 degrees Fahrenheit, which means that it may be slightly higher or lower. Other viscoelastic or viscous materials may be used in lieu of Sorbothane®. For example, the polymer may be a thermoplastic vulcanizate which includes a mixture of polypropylene and vulcanized ethylene propylene diene monomer where the polypropylene is a continuous phase of the thermoplastic vulcanizate. One such material is Sarlink® 3140 manufactured by DSM. In another embodiment, the polymer may be a viscoelastic material which includes an amorphous mixture of butyl and chloroprene polymers such as NAVCOM™, which is a product of Allsop/Sims Vibration. In other embodiments, the viscoelastic material for forming particles 20 may be a polyvinyl chloride.

It is contemplated that viscoelastic materials having tangent delta values other than those disclosed above may be used. For example, particles 20 may be formed of a viscoelastic material having a durometer of 30 Shore 00, at ambient temperature such material is characterized as having tan delta values of at least approximately 0.15 or 0.20 at 5 Hertz excitation, 0.20 or 0.25 at 15 Hertz excitation, and/or 0.30 or 0.35 at 30 Hertz excitation, each taken at 2% strain and 20% compression. Particles 20 may also be formed of a viscoelastic material having a durometer of 50 Shore 00, at ambient temperature such material is characterized as having tan delta values of approximately 0.30 or 0.35 at 5 Hertz excitation, 0.40 or 0.45 at 15 Hertz excitation, and/or 0.40 or 0.45 at 30 Hertz excitation, each taken at 2% strain and 20% compression. Particles 20 may also be formed of a viscoelastic material having a durometer of 70 Shore 00, at ambient temperature such material is characterized as having tan delta values of at least approximately 0.40 or 0.45 at 5 Hertz excitation, 0.45 or 0.50 at 15 Hertz excitation, and/or 0.45 or 0.50 at 30 Hertz excitation, each taken at 2% strain and 20% compression. Ambient temperature is room temperature, which is generally between approximately 60-80 degrees Fahrenheit, which means that it may be slightly higher or lower.

In other embodiments, particles 20 are formed of energy dampening material that is selected based on a predetermined minimum specific gravity. Specific gravity is defined as the ratio of the density of a given solid or liquid substance to the density of water at a specific temperature and pressure. Substances with a specific gravity greater than one are denser than water, and so (ignoring surface tension effects) such substances will sink in water, and those with a specific gravity of less than one are less dense than water, and therefore will float in water. In one embodiment, a material having a minimum specific gravity of at least 0.90 may be utilized. In other embodiments, the specific gravity is at least approximately 1.1, or at least approximately 1.3. It is contemplated, however, that materials having other specific gravities may be used.

In still other embodiments, particles 20 are formed of energy dampening material that is selected based on a predetermined durometer. Durometer is a measurement of the material hardness. In particular embodiments, particles 20 are formed of a material having a durometer of approximately 70 shore 00 or less, 50 shore 00 or less, or 30 shore 00 or less. In other embodiments, the durometer is approximately 70 shore A or less, 50 shore A or less, or 30 shore A or less. It is contemplated, however, that materials having other durometers may be used. In particular embodiments, particles 20 having a lower durometer are sized smaller than particles 20 having a larger size.

Pneumatic tires are pressurized with an air or other gas, usually through a valve stem having a passageway extending between the pressurization chamber I and the outside of tire 11. Presently, a filter is used with the valve stem to prevent the inadvertent release of particles 20 from the pressurization chamber, and/or to otherwise prevent particles 20 from become lodged in the valve stem. In an effort to eliminate the use of a filter, in particular embodiments, particles 20 have a predetermined minimum particle size or diameter which is greater than the passageway of the valve stem. In particular embodiments, particles 20 are at least 0.1875 inches in diameter, or at least 0.25 inches in diameter. In other embodiments, particles 20 have a diameter approximately equal to at least 0.50 inches, to at least 0.575 inches, to at least 0.600 inches, to at least 0.700 inches, to at least 0.850 inches, to at least 0.950 inches, or to at least 1.0 inches. In other embodiments, the diameter of particles 20 may be 4 inches or more. Particles having any of these sizes may be formed of viscoelastic materials having any of the material properties described in the paragraphs provided above.

As stated before, vibrations and force variations may arise during loaded tire operation, where the forces and vibrations arise at least in part due to the tire deflecting as it enters and exits the tire footprint. Further, forces and vibrations arise when the tire impacts an object, such as a pothole or other object present on the operating or road surface R. Accordingly, by providing particles 20 that freely operate within the pressurization chamber of a tire, particles 20 are able to migrate to particular interior surfaces of the tire for the purpose of correcting, at least in part, the force variations and vibrations operating within and/or upon the tire. Further, the energy absorbing properties of particles 20 improve the effectiveness of the particles by allowing the particles 20 to absorb and/or interfere with at least a portion of the vibrations (i.e., frequencies) and forces operating within and upon the tire 11. This not only continues to allow the particles 20 to operate as particle dampers, whereby particles dampen the forces and vibrations by impacting the surfaces of the tire to interfere with the undesired forces and/or vibrations, it also provides a material that also dampens the forces and vibrations. Now, in effect, there are two means of dampening occurring—particle (impact) dampening, and material dampening, each of which disrupt and destructively interfere with the forces and vibrations operating upon tire 11. Still further, by utilizing a dampening (energy and force absorbing) material, particles 20 rebound less after impacting the inner tire surface or another particle, which now allows the particles to adapt and settle into place more quickly about the tire. This may also improve tire rolling resistance.

Rolling resistance is the tendency of a loaded tire to resist rolling, which is at least partially caused by the tire deflecting as it enters the tire footprint. As the tire enters the footprint, the tire deflects and the tread impacts the operating or road surface R, which generates resistive forces as well as force variations and vibrations extending from the footprint. By using particles 20 that more readily absorb energy upon impact, particles 20 are better able to overcome a tire's tendency to resist rolling by absorbing the forces and vibrations. Further, by increasing the overall weight of the total quantity of particles 20 present in the pressurization chamber I, more momentum is provided by the particles as the tire rotates. This is beneficial to overcoming (improving) the rolling resistance of a tire 11, as the additional momentum is useful to overcome the forces resisting tire rotation. The overall increase in weight is provided by increasing size and mass of particles 20, and/or increasing the quantity of particles 20 present within the pressurization chamber I. For example, by providing 20 ounces of particles 20 within the pressurization chamber I of a 22 inch diameter tire, the particles 20 provide approximately 61 pounds of force as the tire rotates on a vehicle traveling at approximately 67 miles per hour. In comparison, providing 12 ounces of particles 20 within the pressurization chamber I of the same tire 11 provides approximately 36 pounds of force. Accordingly, by providing more particle weight within the pressurization chamber I, higher levels of force variations and vibrations may be reduced and/or overcome, and rolling resistance may be reduced due to the increase in momentum, as well as the reduction in force variations and vibrations. In particular embodiments, at least approximately 10 ounces of particles 20 are placed within pressurization chamber I of a passenger car tire-wheel assembly 10. In other embodiments, at least approximately 15 ounces or at least approximately 20 ounces of particles 20 are placed within the pressurization chamber I of a passenger car tire-wheel assembly 10. In other embodiments, smaller weight amounts of particles 20 may be placed within a pressurization chamber I of a motorcycle tire, for example, or larger amounts in earthmover or airplane tires, for example. One or more balance weight products, such as lead weights, may also be used to correct tire or wheel mass imbalances, in concurrent use with dampening particles 20 for the correction of force variations and vibrations.

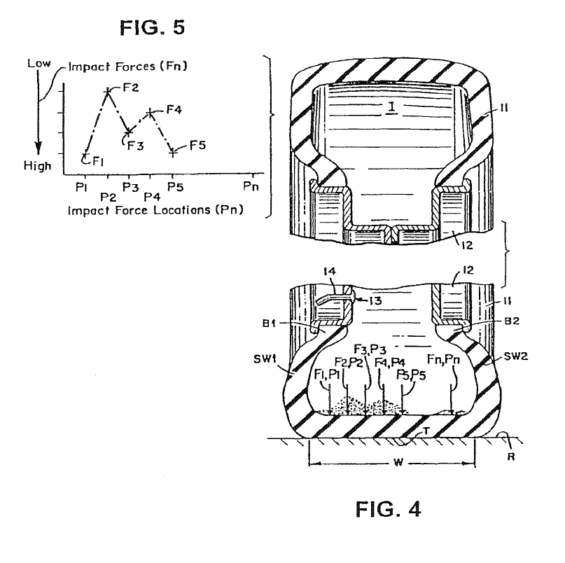

Reference is made to FIGS. 4 and 5 which illustrate the innumerable radial impact forces (Fn) which continuously react between the road R and the tread T at the lower portion or footprint B during tire-wheel assembly rotation. There are an infinite number of such forces Fn at virtually an infinite number of locations (Pn) across the lateral width W and the length L of the footprint B, and FIGS. 4 and 5 diagrammatically illustrate five such impact forces F1-F5 at respective locations P1-P5. As is shown in FIG. 5, it may be assumed that the forces F1-F5 are different from each other because of such factors as tire wear at the specific impact force location, the road condition at each impact force location, the load upon each tire-wheel assembly, etc. Thus, the least impact force may be the force F1 at location P1 whereas the greatest impact force may be the force F2 at location P2. Once again, these forces F1-F5 are merely exemplary of innumerable/infinite forces laterally across the tire 11 between the sidewalls SW1 and SW2 and circumferentially along the tire interior which are created continuously and which vary as the tire-wheel assembly 10 rotates.

As these impact forces are generated during tire-wheel assembly rotation, the particles 20 operate as impact or particle dampers to provide another means of dampening vibrations, frequencies, and/or resistive rolling forces, which is in addition to each being absorbed at least in part due to the viscous properties of the viscoelastic material used to form particles 20, as discussed above. Subsequently, particles 20 may relocate from their initial position in dependency upon the location and the severity of the impact forces Fn to correct any existing force variations. The relocation of the particles 20 may be inversely related to the magnitude of the impact forces. For example, the greatest force F1 (FIG. 5) may be at position P1, and due to these greater forces F1, the particles 20 may be forced away from the point P1 and the smallest quantity of the particles remains at the point P1 because the load force thereat is the highest. Contrarily, the impact force F may be the lowest at the impact force location point P2 and, therefore, more of the particles 20 will remain thereat (FIG. 4). In other words, at points of maximum or greatest impact forces (F1 in the example), the quantity of the particles 20 is the least, whereas at points of minimum force impact (point P2 in the example), the quantity of particles 20 may be proportionately increased, thereby providing additional mass which may absorb and dampen the vibrations or impact forces Fn. Accordingly, the vibrations or impact forces Fn may force the particles 20 to continuously move away from the higher or excessive impact forces F1 and toward the areas of minimum impact forces F2.

Particles 20 may be moved by these impact forces Fn radially, as well as laterally and circumferentially, but if a single force and an individual particle of the particles 20 could be isolated, so to speak, from the standpoint of cause and effect, a single particle located at a point of maximum impact force Fn would be theoretically moved 180 degrees there from. Essentially, with an adequate quantity of particles 20, the variable forces Fn create, through the impact thereof, a lifting effect within the tire interior I which at least in part equalizes the radial force variation applied against the footprint until there is a total force equalization circumferentially and laterally of the complete tire-wheel assembly 11. Thus the rolling forces created by the rotation of the tire-wheel assembly 11 in effect create the energy or force Fn which is utilized to locate the particles 20 to achieve lift and force equalization and assure a smooth ride. Furthermore, due to the characteristics of the particles 20 as described below, road resonance may be absorbed as the tire-wheel assemblies 10 rotate.

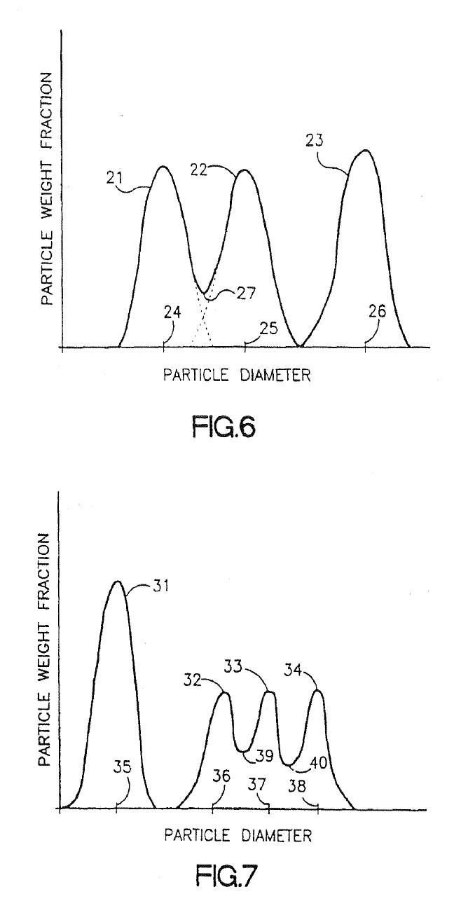

Referring now to FIGS. 6 and 7, graphs are shown of typical multimodal compositions. The graphs are a plot of weight fraction versus particle diameter with both increasing with distance from zero point at the lower left side of the graph. FIG. 6 depicts a trimodal composition having three distinct particle diameter ranges 21, 22, and 23. The ranges are centered about midpoint of the each range identified as 24, 25, and 26, respectively. Ranges 21 and 22 are shown to overlap at area 27. Although not shown, areas of overlap may result in another smaller mode having a peak particle weight fraction at the point of intersection of the ranges. Range 23 does not overlap with any other range. FIG. 7 depicts a multi-modal composition having one non-overlapping particle diameter range 31 and three overlapping particle diameter sizes 32, 33, and 34. The ranges are centered about midpoint of the each range identified as 35, 36, 37, and 38, respectively. While the particle weight fraction for each group was generally the same in FIG. 6, the particle weight fraction of range 31 is significantly larger than that of the other groups. Ranges 32, 33, and 34 are shown to overlap at areas 39 and 40.

The particles 20 may include a mixture of particles having differing particle sizes. In one embodiment, the mixture may include a set of particles having a first particle size and a set of particles having a second particle size. In another embodiment, the particles 20 may include a mixture of a first set of particles having a first size range and a second set of particles having a second size range, where the particle size distribution of the mixture is characterized by at least two modes (i.e., the distribution is multimodal). That is, a plot of weight fraction versus particle diameter or size will show two or more particle sizes or particle size ranges having relatively high concentration of particles, separated by a region of particle size range in which there are no particles or few particles. In another embodiment, the particles 20 may include a mixture of particles having a trimodal particle size distribution. In one such embodiment, the first mode may be at least approximately 0.550 inches, the second mode may be at least approximately 0.575 inches, and the third mode may be at least approximately 0.600 inches. In other embodiments, each of the modes may include particles 20 having any size or diameter identified above in paragraph 32. A benefit of a multimodal particle size distribution is that the smaller sized particles may respond quickly to smaller forces, whereas the larger particles may provide additional energy absorption and force dampening in response to larger forces.

As the tire-wheel assembly 10 is rotating, the particles 20 may be tumbling within the assembly 10 until the assembly 10 and particles 20 are subjected to sufficient centripetal force such that the particles 20 may be “pinned” to the interior surface of the tire 11. While tumbling in the assembly 10, the particles 20 may repeatedly impact the interior surfaces of the assembly 10 as well as others of the plurality of particles 20, which may lead to surface wear and degradation of the particles 20. Thus, the particles 20 may be selected to have a predetermined hardness or hardness range which is sufficient to prevent the particles 20 from degrading while tumbling in the assembly 10. In one embodiment, the hardness range of the particles 20 may be from no more than approximately 30 to 70 Shore 00 hardness, or 30 to 70 Shore A hardness.

Although the invention has been described with reference to certain preferred embodiments, as will be apparent to those skilled in the art, certain changes and modifications can be made without departing from the scope of the invention as defined by the following claims.

What is claimed is:

1. A system for improved correction of force variations and/or dampening of vibrations in a pneumatic tire-wheel assembly comprising:
a plurality of dampening particles adapted for placement within the tire-wheel assembly,
wherein said particles are formed of at least one energy dampening viscoelastic material.

2. The system of claim 1, wherein the at least one energy dampening material has a durometer of at least approximately 30 Shore 00, and a tangent delta of at least 0.15 at 5 Hertz excitation, taken at ambient temperature and at 2% strain and 20% compression.

3. The system of claim 1, wherein the at least one energy dampening material has a durometer of at least approximately 50 Shore 00, and a tangent delta of at least 0.30 at 5 Hertz excitation, taken at ambient temperature and at 2% strain and 20% compression.

4. The system of claim 1, wherein the at least one energy dampening material has a durometer of at least approximately 70 Shore 00, and a tangent delta of at least 0.35 at 5 Hertz excitation, taken at ambient temperature and at 2% strain and 20% compression.

5. The system of claim 1, wherein said viscoelastic dampening material is a thermoplastic vulcanizate.

6. The system of claim 5, wherein said thermoplastic vulcanizate comprises a mixture of polypropylene and vulcanized ethylene propylene diene monomer.

7. The system of claim 6, wherein said polypropylene comprises a continuous phase of said thermoplastic vulcanizate.

8. The system of claim 1, wherein said viscoelastic dampening material comprises an amorphous mixture of butyl and chloroprene polymers.

9. The system of claim 1, wherein said at least one energy dampening material has a minimum specific gravity of at least approximately 0.90.

10. The system of claim 1, wherein the dampening particles are at least approximately 0.1875 inches in diameter.

11. The system of claim 1, said dampening particles comprising a mixture of dampening particles, said mixture comprising a first set of particles having a first modal particle size, a second set of particles having a second modal particle size, a third set of particles having a third modal particle size, wherein the first modal particle size is at least 0.550 inches, the second modal particle size is at least 0.575 inches, and the third modal particle size is at least 0.600 inches.

12. The system of claim 1, wherein said dampening particles have a hardness of 30-70 Shore 00 hardness or A hardness.

13. The system of claim 1, wherein said viscoelastic material comprises polyvinyl chloride.

14. A method for improving equalization of force variations and/or vibrations of a pneumatic tire-wheel assembly comprising the steps of:
providing a pneumatic tire-wheel assembly;
providing a plurality of impact dampening particles, wherein the particles are formed of at least one energy dampening viscoelastic material; and,
placing said plurality of particles in free movable relationship into a pressurization chamber within said tire-wheel assembly for improving equalization of any force variations and/or vibrations of the tire-wheel assembly upon rotation of the tire-wheel assembly.

15. The method of claim 14, further comprising the step of:
placing at least one balance weight along the tire-wheel assembly to substantially correct any imbalances within the tire-wheel assembly.

16. The method of claim 14, further comprising the step of:
determining that the tire-wheel assembly has force variations for correction.

17. The method of claim 14, wherein the at least one energy dampening material has a durometer of approximately at least 30 Shore 00, and a tangent delta of at least 0.25 at 5 Hertz excitation, taken at ambient temperature and at 2% strain and 20% compression.

18. The method of claim 14, wherein the at least one energy dampening material has a durometer of approximately at least 50 Shore 00, and a tangent delta of at least 0.45 at 5 Hertz excitation, taken at ambient temperature and at 2% strain and 20% compression.

19. The method of claim 14, wherein the at least one energy dampening material has a durometer of approximately at least 70 Shore 00, and a tangent delta of at least 0.50 at 5 Hertz excitation, taken at ambient temperature and at 2% strain and 20% compression.

20. The method of claim 14, wherein said viscoelastic dampening material is a thermoplastic vulcanizate.

21. The method of claim 20, wherein said thermoplastic vulcanizate comprises a mixture of polypropylene and vulcanized ethylene propylene diene monomer.

22. The method of claim 21, wherein said polypropylene comprises a continuous phase of said thermoplastic vulcanizate.

23. The method of claim 14, wherein said viscoelastic dampening material comprises an amorphous mixture of butyl and chloroprene polymers.

24. The method of claim 14, wherein said at least one energy dampening material has a minimum specific gravity of at least approximately 0.90.

25. The method of claim 14, wherein said at least one energy dampening material has a minimum specific gravity of at least approximately 1.30.

26. The method of claim 14, wherein the dampening particles are at least approximately 0.1875 inches in diameter.

27. The method of claim 14, wherein the dampening particles are at least approximately 0.2500 inches in diameter.

28. The method of claim 14, said dampening particles comprising a mixture of dampening particles, said mixture comprising a first set of particles having a first modal particle size, a second set of particles having a second modal particle size, a third set of particles having a third modal particle size, wherein the first modal particle size is at least 0.550 inches, the second modal particle size is at least 0.575 inches, and the third modal particle size is at least 0.600 inches.

29. The method of claim 14, wherein said dampening particles have a hardness of 30-70 Shore 00 or Shore A hardness.

30. The system of claim 1, wherein said viscoelastic material comprises polyvinyl chloride.
